(19) United States
(12) Patent Application Publication
(10) Pub. No.: US 2024/0344900 A1
(43) Pub. Date: Oct. 17, 2024

(54) SYSTEM FOR MEASURING THE TEMPERATURE OF THE SYNGAS LEAVING A REFORMING TUBE

(71) Applicant: L'AIR LIQUIDE, SOCIETE ANONYME POUR L'ETUDE ET L'EXPLOITATION DES PROCEDES GEORGES CLAUDE, Paris Cedex 07 (FR)

(72) Inventors: Guillaume LODIER, Senlisse (FR); Diana TUDORACHE, Bures-sur-Yvette (FR); Daniel GARY, Montigny-le-Bretonneux (FR); Antoine HSU, Paris (FR)

(21) Appl. No.: 18/034,485

(22) PCT Filed: Oct. 20, 2021
(86) PCT No.: PCT/EP2021/079032

§ 371 Date: Apr. 28, 2023

(30) Foreign Application Priority Data
Oct. 28, 2020 (FR) FR2011036

(51) Int. Cl. G01K 13/024; G01K 1/14

(52) U.S. Cl. CPC G01K 13/024; G01K 1/14

(57) ABSTRACT

A system for measuring a specific temperature for at least one reforming tube present in a steam methane reforming furnace having, for at least one row of tubes, a means for measuring at least one synthesis gas temperature at the tube outlet, the measuring means being disposed along the length of the manifold associated with the row of tubes provided with at least one temperature sensor, a second part extending the first part, and a third part having instrumentation configured for calculating the temperature from the data acquired by the first part of the means and transferred by the second part of the means. A positioning means for positioning the temperature sensor in the longitudinal manifold, and a sealed outlet means for the second part of the measurement means toward the outside of the system for collecting the synthesis gas.

### CROSS REFERENCE TO RELATED APPLICATIONS

This application is a 371 of International Application No. PCT/EP2021/079032, filed Oct. 20, 2021, which claims priority to French Patent Application No. 2011036, filed Oct. 28, 2020, the entire contents of which are incorporated herein by reference.

### BACKGROUND

The invention relates to the field of the production of synthesis gas by steam reforming.

The present invention relates more particularly to a system for measuring specific temperatures of the reforming tubes present in a steam reforming furnace.

Steam methane reforming (SMR) furnaces are used for producing hydrogen, carbon monoxide and synthesis gas. The reactions for reforming the hydrocarbon feedstock are endothermic; they require a great deal of heat.

The reforming furnace (or reformer), which is usually a construction of parallelepipedal shape, is produced with elements made of ceramic bricks; it has heat sources in the form of burners that are generally aligned and usually installed along the vertical lateral walls (better known as side-fired technology) or horizontally along the roof or the bottom of the furnace (top-fired and bottom-fired technology respectively). Catalytic tubes are disposed vertically, in rows in the combustion chamber of the furnace; the reforming reactions take place in these catalytic tubes that are dimensioned in terms of length, in terms of diameter and in terms of wall thickness to allow the reactions to be completed, targeting a process efficiency close to thermodynamic equilibrium. In a given furnace, these tubes have uniform dimensions (typically of the order of 12 m in height and 10 to 13 cm in internal diameter, with walls 1 to 1.8 cm thick).

The reforming tubes of one and the same row are connected at the outlet to a single manifold pipe that recovers the syngas produced by the tubes. Conventionally, the reformed gas exits at the bottom end of the reforming tubes, this pipe, called “longitudinal manifold” (also called “outlet collector”) in the following text, is placed longitudinally beneath the row of tubes. The longitudinal manifold is itself connected to a transverse manifold (also called “cross header”) that recovers the syngas coming from all the longitudinal manifolds connected to the various rows of tubes, thus collecting all the syngas produced in the reforming furnace.

In the configuration illustrated in [FIG. 3], the transverse manifold is disposed in the same horizontal plane as the longitudinal manifolds, perpendicular to them; it is connected to the manifolds at one end, each longitudinal manifold therefore has one end opening into the transverse manifold, the other end being closed. According to another configuration, the transverse manifold can be disposed beneath the longitudinal manifolds in a plane parallel to that of said manifolds to which it is connected in their central part; each longitudinal manifold is closed at its ends, the two parts of the longitudinal manifold that are situated on either side of the transverse manifold therefore open into the latter via a common outlet.

In the furnace, the transfer of heat between the flames of the burners and the inside of the reforming tubes plays a major role in the efficiency of the process, and even if the SMR furnaces are designed in such a way as to ensure the most homogeneous possible transfer of heat between the flames and the tubes, the manufacture of the furnaces and differences in the filling of the tubes can lead to a dispersion (or spread) of the temperatures between the tubes, having the effect of reducing the efficiency of the reforming process.

Provided that the dispersion of the temperatures between the various tubes can be estimated, it can be reduced; there are curative solutions for this, either by acting on the power of the burners independently of one another, or by adjusting the flow rate of feedstock gas supplying each reforming tube.

However, whatever the curative method used, its efficiency remains conditioned by the availability of reliable, quality temperatures.

Conventionally, in order to acquire these temperatures, a measurement is taken, in the chamber of the furnace, of the temperature of the walls of the reforming tubes on the outside of the tubes, which is called skin temperature. This temperature can be obtained using, for example:
a pyrometer, or
an infrared (IR) camera operating for example at a wavelength of 3.1 μm, or
by welding contact thermocouples to the tube at different elevations of the tube but taking this measurement in the combustion chamber, in a hostile environment and at a high temperature of the order of 1200° C., is difficult.

It is also possible to measure the temperature inside the tubes, but this measurement is tricky to implement: the measurement system installed will modify the stack of the catalyst, resulting in preferential passages and therefore locally in hot spots, and furthermore, the actual installation of the system in a top-heated furnace of which the reforming tubes are also supplied with gaseous feedstock from the top is tricky.

There is therefore a need for a means that makes it possible to measure a representative temperature of each reforming tube individually, without the measurement being taken inside the reforming tube, or in the chamber of the furnace outside the tube.

The inventors have discovered that the behavior of the synthesis gas in the longitudinal manifold near the outlet of a reforming tube—in particular the fact that it does not mix immediately with the synthesis gas from the neighboring tubes and/or circulating in the longitudinal manifold—made it possible to access a specific temperature of said tube, whatever the tube, via a measurement of synthesis gas temperature in the longitudinal manifold at the outlet of the tube.

The object of the invention is therefore to take, in the synthesis gas, in the longitudinal manifold at the mouth of the reforming tubes, temperature measurements representative of the temperature of the synthesis gas leaving the tube. The measurements can be used to improve the efficiency of the synthesis gas production without risking the safety of the installation. These measurements taken at the manifold and representative of the temperature of the syngas leaving each tube individually could in particular highlight differences in behavior of the tubes between one another, and therefore the inhomogeneity of the transfer of heat between the tubes.

For this, a first aspect of the invention relates to a system for measuring a specific temperature for at least one reforming tube present in a steam methane reforming furnace in which reforming tubes disposed vertically in rows are supplied at the inlet with a gaseous reaction mixture and produce a synthesis gas at the tube outlet, a set of longitudinal tubular manifolds is disposed in a plane perpendicular to the rows of tubes, beneath said rows, so as to collect the synthesis gas produced, the tubes of a given row opening into a longitudinal manifold that is associated therewith, all the longitudinal manifolds opening into a transverse manifold, all the longitudinal manifolds and the transverse manifold forming the system for collecting the synthesis gas, the system being characterized in that it comprises, for at least one row of tubes:
at least a means for measuring at least one synthesis gas temperature at the tube outlet; the means being disposed along the length of the manifold associated with said row of tubes and comprising at least a first part of tubular shape disposed along the length of said longitudinal manifold and provided with at least one temperature sensor so as to acquire temperature data, which sensor is positioned in the synthesis gas at the mouth of a reforming tube of the row of which the temperature of the outlet synthesis gas is measured, a second part extending the first part that is able to ensure the transfer of the temperature data acquired by the sensor to the outside of the longitudinal manifold, and as far as the third part, a third part comprising instrumentation for calculating the temperature from the data acquired by the first part of the means and transferred by the second part of the means,
a means for positioning the temperature sensor in the longitudinal manifold that ensures its positioning in the flow of synthesis gas at the mouth of the tube, before it is mixed with the synthesis gas coming from the other tubes opening into the manifold,
a sealed outlet means for the second part of the measurement means toward the outside of the system for collecting the synthesis gas.
   Thus, the measurement system makes it possible to measure the temperature at the outlet of a tube, or of a plurality of reforming tubes of a row by virtue of a set of temperature sensors positioned with precision at the outlet of said tubes in the row. It is possible to equip one row, a plurality of rows or all the rows of tubes in the furnace; in the equipped rows, it is possible to control the temperature at one tube, a plurality of tubes or all the tubes. It will thus be possible to have access to all the synthesis gas temperatures at the outlet of all the tubes or of a selection of tubes.

Aside from the features set out in the previous paragraphs, the temperature measurement system according to the first aspect of the invention may have one or more additional features from among the following, considered individually or in any technically possible combinations.

According to one non-limiting embodiment,
for at least one row of tubes, the system comprises one or more measurement means of which the first part is provided with a single temperature sensor positioned at the mouth of a tube of which it measures the temperature of the outlet synthesis gas using a dedicated positioning means and of which the second part extending the first part and able to ensure the transfer of the temperature data acquired by the sensor to the instrumentation has a sealed outlet means toward the outside of the system for collecting the synthesis gas,
the measurement means disposed along the length of the longitudinal manifold is a multipoint measurement means having a plurality of sensors disposed along the first part of the measurement means so as to be placed at the mouth of the tubes of which the temperature of the outlet synthesis gas is measured,
the sensor measuring the synthesis gas temperature at the outlet of a reforming tube is positioned in the manifold, along the axis of the tube where it opens into the manifold, at a maximum distance, measured from where the tube opens into the manifold, of twice the inner diameter of the tube measured where it opens into the manifold,
the positioning of the sensors is ensured via a plurality of fastening means distributed along the first part of the temperature measurement means that ensure the overall fastening of the measurement means to the manifold at its first part,
the fastening means that ensure the overall fastening comprise a support element on which the measurement means rests and a positioning piece rigidly connected to the support element and to at least one fixed point of the manifold or of a reforming tube opening into the manifold,
the positioning piece is constituted of one or more rigid parts that connect the support element to the walls of the manifold and ensure it is centered and held in position,
the fastening means is positioned at a tube outlet terminating vertically in the manifold, the positioning piece being constituted of a rigid shaft secured to the tube at its upper end, by fastening to the inner wall of the tube or to an element itself secured to the tube, for example to a catalyst support, and at its lower end secured to a support element on which the measurement means rests,
the second part of the measurement means exits toward the outside of the system for collecting the synthesis gas directly from an end of the longitudinal manifold that is closed by a flange, said flange being provided with the sealed outlet means for the second part of the measurement means toward the outside of the system for collecting the synthesis gas,
the second part of the measurement means exits toward the outside of the system for collecting the synthesis gas, passing via the transverse manifold connected to the longitudinal manifold and through the wall of the transverse manifold, said wall being provided, for this passage, with a sealed outlet means for the second part of the measurement means toward the outside of the system for collecting the synthesis gas,
the temperature measurement means is of the fiber Bragg grating type,
the measurement means is of the multipoint thermocouple type.

A second aspect of the invention relates to a method for measuring a specific temperature for at least one reforming tube implementing any one of the temperature measurement systems as mentioned in the preceding paragraphs, according to which said specific temperature of at least one reforming tube of at least one row of tubes present in a steam methane reforming furnace is measured, in which reforming tubes disposed vertically in rows are supplied with gaseous hydrocarbon and steam and said synthesis gas is recovered at the bottom outlet of the tubes, the synthesis gas is collected in a longitudinal manifold disposed beneath the row of tubes that is associated therewith, all the longitudinal manifolds opening into a transverse manifold, characterized in that, for at least one tube of at least one row of tubes, the synthesis gas temperature at the tube outlet is measured by implementing at least:
a measurement means disposed along the length of the manifold associated with said row of tubes, which means comprises at least a first part of tubular shape disposed along the length of said longitudinal manifold and provided with at least one temperature sensor so as to acquire temperature data, which sensor is positioned in the synthesis gas at the mouth of a reforming tube of the row of which the temperature of the outlet synthesis gas is measured, a second part extending the first part that is able to ensure the transfer of the temperature data acquired by the sensor to the outside of the longitudinal manifold, and as far as the third part, a third part comprising instrumentation for calculating the temperature from the data acquired by the first part of the means and transferred by the second part of the means,
a means for positioning the temperature sensor in the longitudinal manifold that ensures its positioning in the flow of synthesis gas at the mouth of the tube, before it is mixed with the synthesis gas coming from the other tubes opening into the manifold,
a sealed outlet means for the second part of the measurement means toward the outside of the system for collecting the synthesis gas.

### BRIEF DESCRIPTION OF THE DRAWINGS

The invention will be understood better from reading the following description and from studying the accompanying figures, which are given by way of indication and do not in any way limit the invention.

FIG. 1 shows a schematic depiction of a multipoint thermocouple.

FIG. 2 shows a schematic depiction of a fiber Bragg grating.

FIG. 3 is a three-dimensional schematic depiction of an example of a system for collecting syngas produced by a row of reforming tubes.

FIG. 4 is a lateral schematic depiction of the syngas collection system of the previous figure, equipped with a temperature measurement system of multipoint type according to the invention.

FIG. 5 is a schematic depiction of a simulation of the behavior of the syngas at the outlet of the tubes of a row.

FIG. 6 groups together examples (a, b) of schematic depictions of the fastening of temperature sensors in the manifold at the mouth of the reforming tubes.

### DETAILED DESCRIPTION OF PREFERRED EMBODIMENTS

The figures are now presented in detail; unless otherwise indicated, the same element appearing in different figures has the same unique reference.

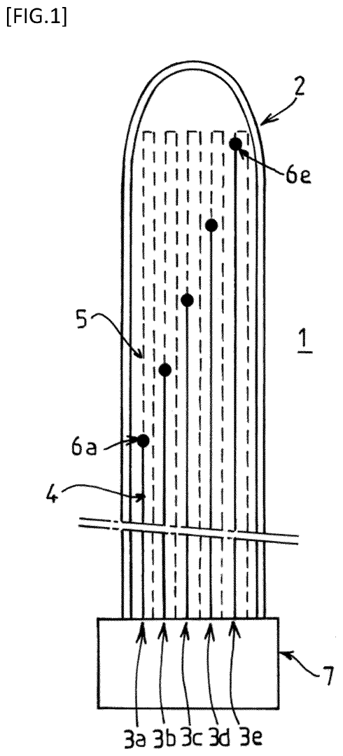

FIG. 1 illustrates a multipoint thermocouple 1, which is in the form of an overall sheath comprising a shell 2 made of refractory metal alloy able to withstand the surrounding conditions (high temperature, corrosion), of Inconel® type for example, one end of which is closed, the opposite end being open, delimiting an inner space in which a plurality of thermocouples will be housed (five in the example shown in the figure, referenced 3a, 3b, . . . , 3e), each thermocouple being constituted of a pair of metal conductors (referenced for the thermocouple 3a): a first conductor 4 represented by a continuous line and a second conductor 5 represented by a broken line, the two conductors being constituted of materials of different electrical conductivities and connected at a point called junction point (referenced 6a in the figure for the thermocouple 3a and Ge for the thermocouple 3e). The space between the thermocouples is advantageously filled with an insulating material of the inorganic oxide type, for example MgO. A multipoint system as presented operates according to the following principle: for each thermocouple (3a, . . . , 3e), for each pair of conductors, the junction point (i.e. 6a, . . . , 6e) constitutes the temperature sensor. For each thermocouple of the measurement system, the information received by the sensor will be transmitted along the conductors as far as the open end of the shell 2 where the pairs of conductors are connected to instrumentation 7 (for example a voltmeter that, for each of the thermocouples, measures the potential difference created at the sensor at the junction between the two metals; coupled with a converter it makes it possible to calculate the corresponding temperature). The multipoint measurement system is designed and the thermocouples are disposed in the sheath such that during the installation of the system in the manifold, the sensors (6a to 6e in the example of the figure) are placed at the precise longitudinal positions along the metal shell 2 that correspond to the predefined positions for the temperature measurements to be taken. The number of pairs of conductors is chosen according to the requirements (five is given here simply by way of illustration). The number of tubes to be equipped is between one and the total number of tubes in the row. The diameter of the shell 2 will depend on the number of thermocouples contained, a jacket with an outer diameter of a quarter of an inch (6.35 mm) being able to contain up to 16 thermocouples.

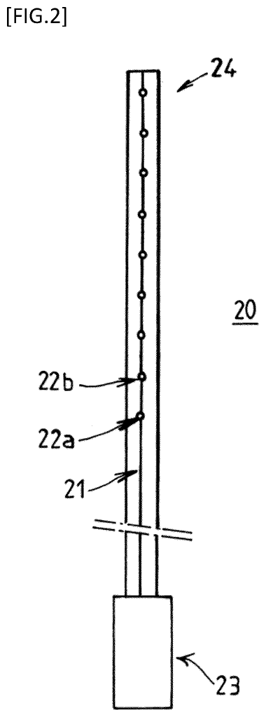

FIG. 2 illustrates a multipoint temperature measurement system 20 of fiber Bragg grating type comprising a very fine optical fiber 21 (diameter of the order of 0.1 mm) within which Bragg gratings (22a, 22b, . . . ) acting as measurement points are inscribed. A wavelength, typically in the 1400-1700 nm range, is associated with each Bragg grating. The Bragg gratings are wavelength multiplexed and can be interrogated simultaneously by instrumentation 23 of interrogator type. The optical fiber and Bragg gratings assembly is protected in a metal shell 24, able to withstand the severe conditions (temperatures up to 950° C., pressure around 30 bar and typical composition of a syngas with mainly H₂, CO and residues). The main advantage of a multipoint temperature measurement system of fiber Bragg grating type lies in its very small size independent of the number of gratings inscribed in the fiber.

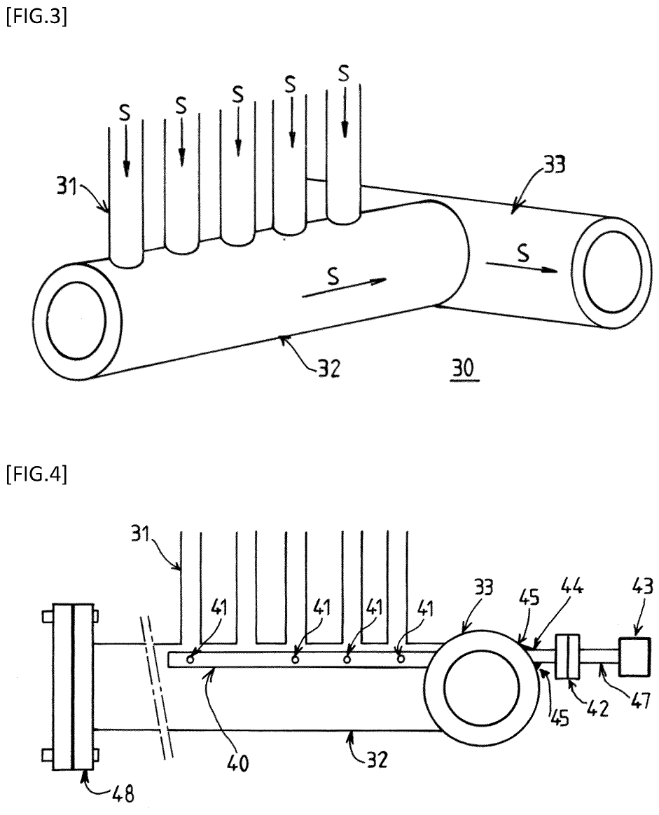

FIG. 3 illustrates a device 30 for collecting the synthesis gas (syngas) S produced in the reforming tubes 31 of a row of tubes of an SMR reformer. Only one row of tubes and one longitudinal manifold 32 are shown in the figure; in practice, the number of longitudinal manifolds corresponds to the number of rows of tubes in the furnace. Each tube outlet opens into the longitudinal manifold 32, which thus collects all the syngas S produced by the tubes of the row. The connection of the tubes to the manifold 32 is done either directly or via a connecting piece. The connecting piece can have different shapes; it can be rectilinear and in this case terminate vertically in the longitudinal manifold (as in the figure), or not, in this case it terminates in the manifold at an angle to the vertical. All the syngas collected in the various manifolds 32 is then recovered in the transverse manifold 33 to which the various manifolds 32 of the reformer are connected. The transverse manifold 33 thus conveys the syngas produced in all the tubes to the rest of the process. In the configuration illustrated in the figure, the transverse manifold 33 is positioned at one end of the longitudinal manifolds; each longitudinal manifold 32 therefore has one end opening into the transverse manifold 33, its other end (not shown) being closed by a flange.

FIG. 4 illustrates a multipoint measurement system according to the invention. The measurement means 40 equipping a syngas collection device of the type of that of the preceding figure for the collection of the syngas produced by five tubes. The measurement means 40 is disposed in the manifold 32 where, for each of the tubes of which it is desired to determine the syngas temperature at the tube outlet—i.e. in the example of the figure for four tubes, no measurement is taken for the second tube from the left in the figure—the system acquires the data by means of the sensors 41 positioned in the syngas at the outlet of the tubes. This first part of the measurement means comprises four surface temperature sensors, positioned in the synthesis gas at the outlet of the tubes of which the temperature of the synthesis gas at the tube outlet is measured. The measurement means 40 is extended beyond this first part by a second part of which the function is to transport all the data acquired beyond the measurement zone, first into the manifold 32, then, passing into the transverse manifold 33 and through the wall of the transverse manifold 33, toward the outside (solution illustrated by the figure); an alternative solution consists of passing through the flange 48 (solution not illustrated by the figure). In all cases, care must be taken that sealing is ensured during the passage through the wall or the flange. Considering the solution shown in the figure, the second part of the system passes through the wall of the transverse manifold via a tapping means 44 welded to the manifold at 45. Since the manifold is subjected to severe conditions of pressure (approximately 30 bar) and temperature (greater than 800° C.) and to an environment rich in hydrogen and carbon monoxide, a means 42 ensures sealing during the passage of the multipoint measurement system through the wall. Beyond that, the conditions (pressure, temperature, composition) are those of the outside atmosphere, and the multipoint measurement means can be connected in complete safety via a transfer cable 47 as far as the instrumentation 43 placed remotely, for example in the control room of the installation where the temperatures can be visualized. This transfer cable may, when the dimensions of the installation so require, have a length of the order of 100 m or more. Appropriate instrumentation (of the converter or interrogator type known per se) provided with a suitable interface will convert the information measured by the sensors into a temperature measurement.

It will also be noted that it is possible, in particular in the cases of use of thermocouples, to use a plurality of independent means instead of a multipoint system, this solution however having no benefit unless the number of independent thermocouples to be installed in the manifold is low, i.e. for reformers of which the number of tubes (to be equipped) per row is limited, the bulk of a device using independent thermocouples becoming excessive if the number of thermocouples to be installed per row increases. For large reforming furnaces, the multipoint system will thus be preferred, except in the case in which it is desired to know the syngas temperature at the outlet of the tubes only for a very limited number of tubes.

It is also possible to install a plurality of multipoint measurement systems in a longitudinal manifold. For example, for long rows of which it is desired to equip a large number of tubes, it may be advantageous to install two or more systems on one and the same row in order to limit the bulk and the length of the part bearing sensors.

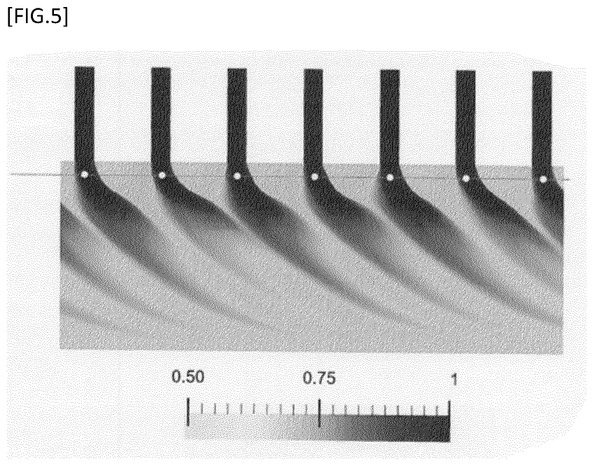

FIG. 5 shows the results of a simulation of the behavior of the synthesis gas at the outlet of the tubes, realized in order to determine the position relative to where a tube opens into the manifold at which a sensor should be disposed so as to collect, in the fluid circulating at this location, data representative of the syngas leaving the tube—i.e. without there having previously been mixing of the synthesis gas leaving the tube with that from the neighboring tubes and/or circulating in the manifold. The objective of the simulation was therefore to highlight in the manifold at the tube outlet a zone in which the synthesis gas leaving the tube had not yet mixed with the synthesis gas coming from the other tubes; the simulation thus highlights a zone where the temperature measured will be that of the synthesis gas where the tube opens into the manifold. This location is where the sensor will be positioned.

For this, a simulation of the behavior of the syngas at the outlet of the tubes under conditions corresponding to those of a furnace in operation was realized for a row of 29 tubes (only seven tubes are shown in the figure). In order for the temperature measurement according to the invention to be relevant, the location chosen for the placement of the sensor has to correspond to the core of the jet generated by the flow of the gas leaving the tube, where the jet of gas leaving the tube is not disturbed by its surroundings. In order to identify the corresponding zone, a tracer was injected (its presence is highlighted by the black color in the figure) at the inlet of the tubes and the behavior of the tracer at the outlet of the tubes was observed, so as to highlight the existence of a zone of non-mixing of the fluids in the manifold in the immediate vicinity of the outlet of the tube, where the tracer had not yet mixed with the gas present in the manifold. The tracer thus makes it possible to visualize the origin of the synthesis gas.

It can thus be seen in the figure that, for each of the tubes shown, the synthesis gas leaving the tube (in black in the figure) tends not to mix quickly with the synthesis gas from the neighboring tubes; for each of the tubes, the gas flows, after having flowed initially and over a first distance along the axis of the tube, are then entrained in a comparable manner for the various tubes, but without mixing, in the direction of the total stream circulating in the manifold, all the gas flows from the tubes then mix with the total flow circulating in the manifold, at a distance from the outlets of the tubes.

It emerges from this simulation of the behavior of the synthesis gas streams where the tubes open into the manifold that, for a given reforming tube, for the sensor placed in the manifold to give a syngas temperature measurement corresponding to that of the syngas leaving this said tube, it has to be disposed in the extension of the tube outlet axis where the tube opens into the manifold (tube outlet axis is understood to mean axis parallel to the walls of the tube at its end and passing through its center), and at a distance less than or equal to twice the diameter of the tube where it opens into the manifold; the outlet axis of the tube being the axis along which the gas flows while entering the manifold.

The diameter to be taken into account is the diameter of the tube (or of the connecting piece when there is one) where it opens into the manifold and not that of the tube in the part containing the reforming catalyst.

Furthermore, if the exit from the tube is effected via a connecting piece that terminates in the manifold at an angle to the vertical, the direction of the “tube outlet axis” that is also the direction of the gaseous stream produced in the tube at the location where it enters the manifold is defined by this same angle and the positioning distance of the sensor is measured in this direction.

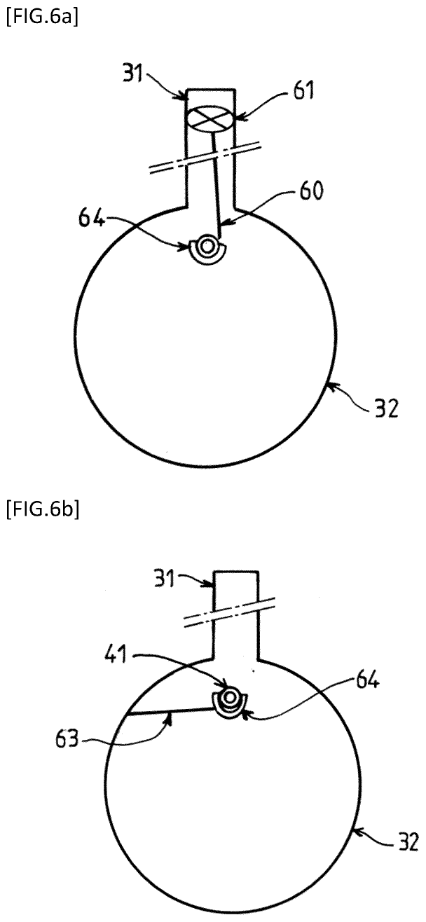

The drawings of FIG. 6 show two schematic examples (a) and (b) of means for fastening the measurement means in the manifold. These fastening means ensure the positioning of the entire measurement means in the manifold, and in particular position the various temperature sensors at the mouth of the reforming tubes, along the outlet axis of the tubes and at the chosen distance. In the examples presented, the sensor is disposed in the manifold 32 vertically relative to the axis of the tube of which it measures the syngas temperature at the tube outlet.

In example (a), the positioning is ensured by a fastening cable 60 (diameter of approximately 2 to 3 mm) that is connected to the support of the catalyst 61 (means ensuring the catalyst is held in the tube); it descends into the connecting piece 31 that extends the reforming tube vertically as far as the manifold (distance of approximately 1 m to 1.5 m), then descends into the longitudinal manifold 32 over a maximum length of 60 mm that corresponds to twice the internal diameter of the connecting piece (short distance that prevents the synthesis gas leaving the tube from mixing with the synthesis gas from the manifold or the neighboring tubes). The cable is provided at its end with a support element 64 that is able to receive and hold in position the measurement means. The example of a support element presented here is in the form of a hook, the measurement means being fastened in the recess of said hook. The fastening of the measurement system is realized in such a way as to ensure the correct positioning of all the sensors 41 of the system. The cable can be connected to any other metal piece present in the tube, or fastened by welding or drilling to the wall of the tube or of the piece for connection to the manifold, provided that the length of the cable is adapted accordingly and that the fastening means (point of fastening to the tube+cable combined with the geometry of the fastening element 64) ensure the alignment of the sensor 41 with the tube outlet axis. This method of fastening from an anchor point situated in the tube (or in the connecting piece) is particularly suitable in the case in which the tube terminates vertically in the manifold. In the other cases, the fastening cable 60 has to be rigid and/or held so as to ensure the positioning of the sensor 41 along the tube outlet axis (recall that the shape of certain connecting pieces leads for example to a tube outlet along a horizontal axis).

The measurement means has an external shell having a rigid external shell; the number of fastening points necessary to ensure its fastening in the manifold will depend on its weight. Each tube is able to be equipped with a fastening means according to example (a), but the adjacent tubes are close (the distance between two tubes is approximately 300 mm) and it is not necessary to have fastening points so close together. In general, the fastening means can be spaced apart by one to several meters without compromising the stiffness of the assembly.

In example (b) the measurement means is fastened to the walls of the manifold. More specifically, the positioning piece is in this case an assembly formed by a connecting piece (bridge) 63 connecting a point of the internal wall of the longitudinal manifold to the support element 64 that is able to receive and hold in position the measurement means; the fastening element 64 shown is a U-shaped piece, the measurement system being fastened in the recess of said piece (this is obviously only one example of a shape).

The connection between the wall of the manifold and the fastening member can be made from a single point on the wall of the manifold in the form of a support bridge (rigid piece of elongate shape connecting the wall of the manifold to the piece 64 receiving the measurement system of circular (or other) section of diameter (or section) similar to the diameter of the measurement system (i.e. of the order of 5 mm for a system with a thermocouple), or from a plurality of points, it being possible for the section of the connecting pieces in this case to be smaller. If the manifold is thermally insulated from the inside, then the support bridge 63 will preferably be one (or more) ceramic piece(s) fastened to the internal wall of the manifold 32 with a high temperature refractory adhesive. If the manifold is not insulated from the inside, then metal elements will be used: the support bridge 63 will be one (or more) metal pieces(s) (pipe, bar, etc.) that can be welded directly to the internal wall of the manifold.

Preferably, successive support bridges will be positioned in a staggered manner (one on the left, one on the right), i.e. between two or more tubes spaced 0.5 meter to several meters apart. It will be noted that this method of fastening is independent of the method of connection of the reforming tubes to the manifold, whether it is done vertically relative to the manifold or at an angle to the vertical.

The invention is not limited to this arrangement in which the tubes are disposed in parallel rows, each one being connected to a syngas manifold; it can be applied for example to the syngas manifolds of reformers of cylindrical type. In this configuration (not shown), the reforming tubes placed vertically in a circular arrangement are connected at their outlet to a single ring-shaped manifold. The syngas is discharged via a recovery pipeline. The temperature measurement system according to the invention can be installed in the circular manifold in the same way as in a rectilinear manifold; the same means for positioning the sensors can be used. The transfer of the data measured outside the manifold can be done via a sealed outlet through a wall of the manifold with connection to the transfer cable as previously described.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-13. (canceled)

14. A system for measuring a specific temperature for at least one reforming tube present in a steam methane reforming furnace comprising:
reforming tubes disposed vertically in rows configured to be supplied at an inlet with a gaseous reaction mixture and configured to produce a synthesis gas at a tube outlet, and
a set of longitudinal tubular manifolds disposed in a plane perpendicular to the rows of tubes, beneath said rows, configured to collect the synthesis gas produced, the tubes of a given row opening into a longitudinal manifold that is associated therewith, all the longitudinal manifolds opening into a transverse manifold, all the longitudinal manifolds and the transverse manifold forming the system for collecting the synthesis gas,
the system comprising, for at least one row of tubes,
a measuring means for measuring at least one synthesis gas temperature at the tube outlet, the measuring means being disposed along the length of the manifold associated with said row of tubes and comprising:
a first part of tubular shape disposed along the length of said longitudinal manifold and provided with at least one temperature sensor configured to acquire temperature data, which sensor is positioned in the synthesis gas at the mouth of a reforming tube of the row of which the temperature of the outlet synthesis gas is measured;
a second part extending the first part configured to ensure the transfer of the temperature data acquired by the sensor to the outside of the longitudinal manifold, and as far as the third part;
a third part comprising instrumentation configured for calculating the temperature from the data acquired by the first part of the means and transferred by the second part of the means;
a positioning means for positioning the temperature sensor in the longitudinal manifold thereby ensuring the positioning in the flow of synthesis gas at the mouth of the tube, before being mixed with the synthesis gas coming from the other tubes opening into the manifold;
a sealed outlet means for the second part of the measurement means toward the outside of the system for collecting the synthesis gas.

15. The measurement system as claimed in claim 14, in which, for at least one row of tubes, the system comprises one or more measuring means of which the first part is provided with a single temperature sensor positioned at the mouth of a tube thereby measuring the temperature of the outlet synthesis gas using a dedicated positioning means and of which the second part extending the first part and able to ensure the transfer of the temperature data acquired by the sensor to the instrumentation has a sealed outlet means toward the outside of the system for collecting the synthesis gas.

16. The measurement system as claimed in claim 14, in which the measurement means disposed along the length of the longitudinal manifold is a multipoint measurement means having a plurality of sensors disposed along the first part of the measurement means so as to be placed at the mouth of the tubes of which the temperature of the outlet synthesis gas is measured.

17. The measurement system as claimed in claim 14, in which the sensor measuring the synthesis gas temperature at the outlet of a reforming tube is positioned in the manifold, along the axis of the tube where opening into the manifold, at a maximum distance, measured from where the tube opens into the manifold, of twice the inner diameter of the tube measured where opening into the manifold.

18. The system as claimed in claim 17, wherein the positioning of the sensors is ensured via a plurality of individual fastening means distributed along the first part of the temperature measurement means that ensure the overall fastening of the measurement means to the manifold at the first part.

19. The system as claimed in claim 18, wherein the individual fastening means that ensure the overall fastening comprise a support element on which the measurement means rests and a positioning piece rigidly connected to the support element and to at least one fixed point of the manifold or of a reforming tube opening into the manifold.

20. The system as claimed in claim 19, in which the positioning piece is constituted of one or more rigid parts that connect the support element to the walls of the manifold and ensure the support element is centered and held in position.

21. The system as claimed in claim 19, in which the fastening means is positioned at a tube outlet terminating vertically in the manifold, the positioning piece being constituted of a rigid shaft secured to the tube at the upper end, by fastening to the inner wall of the tube or to an element secured to the tube and at the lower end secured to a support element on which the measurement means rests.

22. The system as claimed in claim 14, in which the second part of the measurement means exits toward the outside of the system for collecting the synthesis gas directly from an end of the longitudinal manifold that is closed by a flange, said flange being provided with the sealed outlet means for the second part of the measurement means toward the outside of the system for collecting the synthesis gas.

23. The system as claimed in claim 14, in which the second part of the measurement means exits toward the outside of the system for collecting the synthesis gas, passing via the transverse manifold connected to the longitudinal manifold and through the wall of the transverse manifold, said wall being provided, for this passage, with a sealed outlet means for the second part of the measurement means toward the outside of the system for collecting the synthesis gas.

24. The system as claimed in claim 14, in which the temperature measurement means is of the fiber Bragg grating type.

25. The system as claimed in claim 14, in which the temperature sensor used is of the thermocouple type.

26. A method for measuring a specific temperature for at least one reforming tube implementing a temperature measurement system as claimed in claim 14, according to which the temperature of the synthesis gas at the outlet of at least one reforming tube of at least one row of tubes present in a steam methane reforming furnace is measured, in which:
reforming tubes disposed vertically in rows are supplied with gaseous hydrocarbon and steam and
said synthesis gas is recovered at the bottom outlet of the tubes,
the synthesis gas is collected in a longitudinal manifold disposed beneath the row of tubes that is associated therewith, all the longitudinal manifolds opening into a transverse manifold,
wherein, for at least one tube of at least one row of tubes, the synthesis gas temperature at the tube outlet is measured by implementing at least
a measuring means disposed along the length of the manifold associated with said row of tubes, which measuring means comprises:
a first part of tubular shape disposed along the length of said longitudinal manifold and provided with at least one temperature sensor so as to acquire temperature data, which sensor is positioned in the synthesis gas at the mouth of a reforming tube of the row of which the temperature of the outlet synthesis gas is measured;
a second part extending the first part that is able to ensure the transfer of the temperature data acquired by the sensor to the outside of the longitudinal manifold, and as far as the third part;
a third part comprising instrumentation for calculating the temperature from the data acquired by the first part of the means and transferred by the second part of the means;
a positioning means for positioning the temperature sensor in the longitudinal manifold that ensures the positioning in the flow of synthesis gas at the mouth of the tube, before being mixed with the synthesis gas coming from the other tubes opening into the manifold;
a sealed outlet means for the second part of the measurement means toward the outside of the system for collecting the synthesis gas.
